(19) United States
(12) Patent Application Publication
(10) Pub. No.: US 2026/0312305 A1
(43) Pub. Date: Oct. 8, 2026

(54) CONNECTION TERMINAL FOR CONNECTING AN ELECTRICAL WIRE

(71) Applicant: PHOENIX CONTACT GMBH & CO. KG, Blomberg (DE)

(72) Inventor: Dennis GEISLER, Extertal (DE)

(21) Appl. No.: 18/993,018

(22) PCT Filed: Jul. 20, 2023
(86) PCT No.: PCT/EP2023/070125

§ 371 Date: Jan. 10, 2025

(30) Foreign Application Priority Data
Jul. 21, 2022 (LU) LU502538

(51) Int. Cl. H01R 4/48; H01R 9/24

(52) U.S. Cl. CPC H01R 4/483; H01R 4/4811; H01R 4/4819; H01R 4/48365; H01R 4/484; H01R 9/2491; H01R 2201/20

(57) ABSTRACT

A connection terminal for connecting an electrical wire includes: a housing which has an insertion opening into which the electrical wire is insertable for connection to the connection terminal; a contact element which is arranged on the housing and has a contact portion for making electrical contact with the electrical wire; a spring element arranged on the housing and having a clamping leg which is adjustable relative to the housing and which, in a clamping position, acts upon the electrical wire so as to make contact with the contact portion and, in an open position, is remote from the contact portion relative to the clamping position; and a release element. The clamping leg is retained in a position relative to the housing in the open position, and the release element cooperates with the electrical wire upon insertion of the electrical wire into the insertion opening.

### CROSS-REFERENCE TO PRIOR APPLICATIONS

This application is a U.S. National Phase application under 35 U.S.C. § 371 of International Application No. PCT/EP2023/070125, filed on Jul. 20, 2023, and claims benefit to Luxembourg Patent Application No. LU 502538, filed on Jul. 21, 2022. The International Application was published in German on Jan. 25, 2024 as WO/2024/017993 under PCT Article 21(2).

### FIELD

The invention relates to a connection terminal for connecting an electrical wire.

### BACKGROUND

Such a connection terminal comprises a housing which has an insertion opening into which the electrical wire can be inserted for connection to the connection terminal. A contact element which has a contact portion for electrically contacting the electrical wire is arranged on the housing. In addition, a spring element is arranged on the housing, which spring element has a clamping leg which is adjustable relative to the housing and which, in a clamping position, is designed to act upon the electrical wire for making contact with the contact portion and, in an open position, is remote from the contact portion relative to the clamping position.

In the open position, the clamping leg is locked directly or indirectly relative to the housing and is thus held in its open position. If the clamping leg is in the open position, an electrical wire can be connected to the connection terminal by inserting it into the insertion opening. A release element serves to cooperate with the electrical wire, when it is being inserted into the insertion opening, in order to release the clamping leg from the open position.

By using the spring element, such a connection terminal establishes a spring force connection in which, in the connected position, the electrical wire is clamped to the contact element under the elastic action of the spring element and is thus electrically connected to the contact element.

In a connection terminal known from DE 10 2019 127 464 B3, a spring element in the form of a tension spring is provided, which pulls a connected electrical wire into abutment with an associated contact element by the resilient action of the spring and thus establishes a clamping connection between the electrical wire and the contact element. For this purpose, when attaching the electrical wire, it is pushed through an opening in the clamping portion and is clamped between the clamping portion and the contact element when in the connected position.

The connection terminal in DE 10 2019 127 464 B3 provides a locking device used to lock the clamping leg relative to the housing in an open position. When the electrical wire is inserted, the locking device is released, and the locking engagement is therefore released such that clamping leg is moved from the open position, and the electrical wire is thereby clamped to the contact element. In order to move the clamping leg into the open position, in particular to allow the electrical wire to be attached or to release a connected electrical wire from the connection terminal, a tool, e.g., a screwdriver, can be attached to the connection terminal, and a force can thereby be exerted on the clamping leg.

While, in DE 10 2019 127 464 B3, the clamping leg is directly moved by means of a tool, in each of the connection terminals known from DE 10 2019 135 203 A1 and DE 10 2020 104 140 A1, an actuation element in the form of a so-called pusher is provided which can be pushed into the housing of the connection terminal in order to thereby act upon the clamping leg and to transfer the clamping leg into its open position. The actuation element is spring-loaded relative to the housing of the connection terminal via a clamping spring in the form of a compression spring. In the connection terminal known from DE 10 2019 135 203 A1, an actuating lug is arranged on the actuation element, which hooks into a fastening portion of a retaining element when the actuation element is in the actuated position.

In a connection terminal of the type described, it may be desirable to provide a test tap in order to tap a voltage at the connection terminal by attaching a testing tool to the connection terminal. In a conventional connection terminal, such a test tap is often designed in such a way that the testing tool can be brought into contact with the spring element, forming the clamping leg, using a test probe in order to test the voltage at the connection terminal.

It is desirable to provide a test tap which allows the voltage to be tapped even when no electrical wire is connected to the connection terminal, and the clamping leg of the spring element is in the open position. If the clamping leg is in the open position and the connection terminal is delivered in this state, e.g., by a manufacturer, the clamping leg does not make contact with the contact element, such that, under certain circumstances, no voltage can be tapped at the spring element (in particular if the spring element is supported on the housing separately from the contact element).

In a connection terminal known from DE 10 2020 104 138 B4, a test opening is formed on a housing, into which test opening a testing tool can be inserted for making contact with a current bar inside the housing.

### SUMMARY

In an embodiment, the present invention provides a connection terminal for connecting an electrical wire, comprising: a housing which has an insertion opening into which the electrical wire is insertable for connection to the connection terminal; a contact element which is arranged on the housing and has a contact portion configured to make electrical contact with the electrical wire; a spring element arranged on the housing and having a clamping leg which is adjustable relative to the housing and which, in a clamping position, is configured to act upon the electrical wire so as to make contact with the contact portion and, in an open position, is remote from the contact portion relative to the clamping position; and a release element, wherein the clamping leg is retained in a position relative to the housing in the open position, and the release element is configured to cooperate with the electrical wire upon insertion of the electrical wire into the insertion opening so as to release the clamping leg from the open position, and wherein the contact element has a contacting unit configured to make contact with an associated electrical assembly, a first leg extending from the contacting unit and forming the contact leg, and a second leg extending from the contacting unit and forming a tapping portion configured to make electrical contact with a testing tool.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a connection arrangement with a plurality of connection terminals accommodated in a housing;

FIG. 2 is a view of the connection arrangement from the front;

FIG. 3 is a sectional view of a connection terminal along line A-A according to FIG. 2, with the actuation element in a non-actuated position;

FIG. 4A is a view of a housing part of a connection terminal;

FIG. 4B is a view of a housing part of an adjacent connection terminal;

FIG. 5A-5C are separate views of a release element of the connection terminal;

FIG. 6A is a view of a housing part of a connection terminal;

FIG. 6B is an enlarged view of detail X according to FIG. 6A;

FIG. 7A is another view of the housing part of the connection terminal;

FIG. 7B is an enlarged view of detail X according to FIG. 7A;

FIG. 8 is a sectional view along the line B-B according to FIG. 1;

FIG. 9 is a view of an exemplary embodiment of a connection arrangement with a testing tool attached thereto;

FIG. 10 is the sectional view of FIG. 3 with an attached testing tool;

FIG. 11A is a separate view of a contact element of the connection terminal;

FIG. 11B is a side view of the contact element; and

FIG. 12 is a view of an outer housing of the connection arrangement with a testing tool attached.

### DETAILED DESCRIPTION

In an embodiment, the present invention provides a connection terminal which makes it possible, in a simple manner, to tap a voltage at the connection terminal for testing purposes using a testing tool.

Accordingly, the contact element comprises a contacting unit for making contact with an associated electrical assembly, a first leg extending from the contacting unit and forming the contact portion, and a second leg extending from the contacting unit and forming a tapping portion for making electrical contact with a testing tool.

The electrical wire in the connection terminal is electrically contacted by the electrical contact element by the clamping portion acting on the electrical wire when said electrical wire is inserted into the insertion opening and applying an elastic load thereto in the direction of contact with the contact element. To make it easier to attach the electrical wire, the clamping leg of the spring element can be elastically deflected, for example, using a tool or by actuating an actuation element in order to thereby move the clamping leg into an open position in which a space in the region of the insertion opening is cleared, and the electrical wire can accordingly be inserted into the insertion opening substantially without any force, or a connected electrical wire can be easily removed from the connection terminal.

Once the clamping leg has been moved into the open position, the clamping leg is retained in the open position relative to the housing. This can be done by directly locking the clamping leg relative to the housing or by indirect locking—for example, by means of an actuation element. The clamping leg can, for example, be locked in the open position with the release element. Alternatively, an actuation element can be locked on the housing with the release element or with a locking device. In each case, the clamping leg is retained in a position relative to the housing in the open position (directly or indirectly by means of the actuation element) such that a user can insert an electrical wire into the insertion opening in a simple, substantially forceless manner and thus connect it to the connection terminal.

The release element serves to release the clamping leg from the open position in order to automatically release the clamping leg from the open position when the electrical wire is inserted and thus to transfer the clamping leg into a clamping position in which the electrical wire inserted into the insertion opening is electrically contacted by the contact element of the connection terminal. Since the release element is deflected when the electrical wire is inserted, the connection terminal closes automatically when the electrical wire is inserted. This results in a simple connection process, with reliable contact between the wire and the contact element.

Such a connection terminal, in which the clamping leg of the spring element is retained in a position relative to the housing in the open position and which can be automatically released by a release element when an electrical wire is inserted, can be delivered by a manufacturer, for example, with the clamping leg in the open position. In order to provide a test tap on such a connection terminal, which test tap allows a voltage to be tapped at the connection terminal for testing purposes, a tapping portion which allows electrical contact to be made with a testing tool and thus allows a voltage to be tapped at the contact element for testing purposes is formed on the contact element of the connection terminal.

The tapping portion is formed on a leg which protrudes from a contacting unit of the contact element. The contacting unit is used to make contact with an associated electrical assembly. A further leg extending from the contacting unit forms the contact portion for abutting and making contact with a connected electrical wire.

Since the tapping portion with which the testing tool can be brought into contact is formed on the contact element, the test tap takes place on the contact element and is therefore independent of the position of the clamping leg of the spring element. Because the test tap is not carried out on the spring element, it is in particular irrelevant whether the spring element makes contact with the contact element or whether the clamping leg is in the open position in which the clamping leg is remote from the contact portion. The tapping portion on the contact element can therefore be used to tap a voltage at the connection terminal even in the open position of the clamping leg if the spring element is supported on the housing independently of the contact element and is therefore not electrically connected to the contact element.

Since the contact portion for making contact with the electrical wire and the tapping portion for making contact with the testing tool are formed on different legs of the contact element, the test tap can be provided on the connection terminal where a testing tool can be attached to the connection terminal in a space-saving manner. A connected electrical wire makes contact with the contact element via the first leg which forms the contact portion. A testing tool can be contacted by the contact element via the second leg in order to tap a voltage for testing purposes. A contacting unit is formed between the first leg and the second leg, by means of which contacting unit the connection terminal can, for example, be plugged into an associated electrical assembly—for example, a mating connector.

In one embodiment, the contact portion extends in a planar manner along a plane which is spanned by an insertion direction in which the electrical wire can be inserted into the insertion opening and a transverse direction pointing transversely to the insertion direction. The contact portion is therefore designed to be flat and is aligned parallel to the insertion direction in which an electrical wire can be inserted into the connection terminal. When the electrical wire is inserted, it acts upon the release element and thus releases the clamping leg from the open position such that the clamping leg acts upon the electrical wire in a clamping manner and brings it into contact with the contact portion.

In one embodiment, the tapping portion extends obliquely to the insertion direction. The contact portion and the tapping portion are therefore aligned along different directions on the housing. Because the tapping portion extends obliquely, is can in particular point towards a test opening, which is formed on the housing, in order to allow a testing tool to be inserted into the housing.

A test opening provided on the housing for inserting a testing tool can in particular be designed such that the testing tool can be inserted into the test opening along a vertical direction. Preferably, the tapping portion extends obliquely to the vertical direction. The vertical direction can, for example, point perpendicularly to the insertion direction in which an electrical wire can be inserted into the insertion opening of the housing for connection to the connection terminal such that the test portion is aligned obliquely to the vertical direction and obliquely to the insertion direction.

In one embodiment, the tapping portion engages with an end, remote from the contacting unit, in an engagement opening on the housing and is supported thereabove on the housing via said engagement opening. The tapping portion therefore extends from the contacting unit and is supported on the housing at a remote, free end. Bending stress on the tapping portion is thus reduced by supporting load forces applied to the housing by a testing tool and dissipating them into the housing.

In one embodiment, the contact portion points in the direction of the insertion opening with an end remote from the contacting unit. In one embodiment, both the tapping portion and the contact portion are therefore with a free end remote from the contacting unit.

For example, the contact element can be designed as a sheet metal element, e.g., in the form of a stamped and bent part, in which the contact portion, the contacting unit, and the tapping portion are formed by portions of the contact element which are bent towards one another.

In one embodiment, the contacting unit is formed by a contact socket for plugging into the associated electrical assembly. Such a contact socket, e.g., in the form of what is known as a tulip contact, can have contact blades, for example, by means of which the contacting unit can be plugged into an associated electrical assembly in the form of a mating connector. A contact element of the mating connector can be inserted between the contact blades of the contact socket in order to establish an electrical connection between a connector, of which the connection terminal is a component, and the mating connector.

In one embodiment, the spring element is designed as a tension spring. In this case, the clamping portion of the spring element is designed to pull the electrical wire into abutment with the contact element by spring force. In this case, for example, an opening in the clamping leg can be formed through which the electrical wire can be guided when it is inserted into the insertion opening in the housing, in order to pull the electrical wire into clamping contact with the contact element after the clamping leg has been released from the open position.

Alternatively, the spring element can be designed as a compression spring. In this case, the clamping portion is designed to push the electrical wire into abutment with the contact element by spring force. When inserted into the insertion opening, the electrical wire enters a space between the clamping leg and the contact element, wherein, after the clamping leg has been released from the open position, the clamping leg acts upon the electrical wire and pushes it into abutment with the contact element.

The spring element can, for example, have a supporting leg, via which the spring element is supported on the housing and held in position on the housing. The clamping leg can be elastically deflected relative to the supporting leg, wherein, in the open position, the clamping leg is deflected such that the spring element is elastically loaded, and the clamping leg is moved out of the open position under elastic preload after being released from the open position.

The supporting leg can, for example, engage in a supporting opening on the housing and is supported thereabove on the housing by said supporting opening. The spring element is thus attached to the housing independently of the contact element and, if the housing is made of an electrically insulating material, in particular a plastic material, is therefore not directly electrically connected to the contact element.

In one embodiment, the release element comprises a release leg which is designed to cooperate with the electrical wire when inserted into the insertion opening. By cooperating with the electrical wire, the release arm is triggered such that the clamping leg is released from the open position. The housing defines a receiving space into which the electrical wire can be introduced by inserting it into the insertion opening. The release portion extends into the receiving space to interact with the electrical wire. In particular, the electrical wire can be inserted into the insertion opening along an insertion direction, wherein the release leg extends at least with an end portion (approximately) transversely to the insertion direction into the receiving space.

The release element can, for example, be designed as an integral, elastically resilient element.

In one embodiment, the release element has a supporting end relative to which the release leg is elastically adjustable by cooperating with the cable inserted into the insertion opening. The release element is supported on the housing by the supporting end—for example, by the supporting end being fastened to an associated connecting device of the housing. The release element is thus fastened to the housing via the supporting end by the supporting end being operatively connected to a connecting device of the housing and is thereby held thereabove on the housing in a torque-tight manner.

The supporting end is fixed to the connecting device of the housing in a torque-proof manner. The supporting end can extend flat, which has the advantage that a contour can be formed at the supporting end in a simple manner, for example by punching, via which contour it can be reliably, for example interlockingly, fixed to the connecting device of the housing. While the supporting end is supported in a torque-tight manner relative to the housing, the release portion can be elastically moved in the receiving space and extends into the receiving space in such a way that an electrical wire inserted into the insertion opening strikes the release portion when introduced into the receiving space and thus deflects it.

In one embodiment, the supporting end has at least one first interlocking element, while the connecting device of the housing comprises at least one second interlocking element. The at least one first interlocking element and the at least one second interlocking element interlockingly engage with one another to fix the supporting end to the housing. This creates an interlocking connection between the supporting end and the housing such that the supporting end is held on the housing in a torque-tight manner. The release portion can be elastically deflected relative to the supporting portion, wherein the supporting end is fixed to the housing in such a way that a torque can be introduced into the housing via the supporting end and is supported on the housing.

One of the form-fitting elements can be formed by a recess, for example. The other form-fitting element is then formed by a projection element which form-fittingly engages in the recess to fix the supporting end to the housing. For example, the supporting end may have a recess which engages with an associated form-fitting element in the form of a projection element on the housing. The interlocking engagement is in particular such that the supporting end cannot slide off the housing, but is held on the housing in such a way that when the release portion is elastically deflected, the supporting end remains in position on the housing.

In one embodiment, the connection terminal has an actuation element which is adjustably arranged on the housing and can be adjusted from a non-actuated position to an actuated position to transfer the clamping leg into the open position. The actuation element can be actuated by a user, e.g., manually or by means of a suitable tool, and, for this purpose, has an actuating portion which is accessible from outside the housing.

In one embodiment, the actuation element locks into the actuated position with the release element. In the actuated position, the actuation element is accordingly held in position by the release element such that, thereabove, the clamping leg of the spring element is thereby also held in its open position in which it is possible to easily attach an electrical wire to the connection terminal or to remove a connected wire from the connection terminal substantially without any force. After undoing the locking engagement, the actuation element can move back, in particular automatically, toward the non-actuated position, preferably under spring preload. The actuation element can be subjected to spring preload, e.g., by the clamping leg, which is elastically deflected in the actuated position and, after the actuation element has been released, acts upon the actuation element in a resiliently mechanical manner to transfer the actuation element from the actuated position towards the non-actuated position.

In one embodiment, the release portion engages, in a locking position, with the actuation element located in the actuated position. The release portion can be moved from the locking position to release the actuation element from the actuated position by interacting with the electrical wire.

In one embodiment, the actuation element is mounted on the housing so as to be pivotable about a pivot shaft and has an actuating portion for actuation by a user and an active portion for acting upon the clamping leg. While the actuating portion is accessible from outside the housing, for example by a user being able to act on the actuating portion using a tool, such as a screwdriver, or alternatively manually, the active portion is operatively connected to the clamping portion of the spring element. By moving the actuation element, a movement force is thus exerted on the clamping leg via the active portion such that, in particular when the actuation element is moved from the non-actuated position into the actuated position, the clamping leg is entrained and is thus moved in the direction of the open position.

In one embodiment, the actuation element has a locking portion for engaging with a locking device of the release element when in the actuated position. The locking portion can, for example, be arranged on a side of the actuation element facing away from the actuating portion (with respect to the pivot shaft of the pivotable bearing for the actuation element on the housing), preferably approximately diametrically remote from the actuating portion with respect to the pivot shaft. By means of the locking portion, the actuation element is locked in the actuated position by an associated locking device of the release element such that the actuation element is thereby held in the actuated position, but can be released from the actuated position in a simple and reliable manner by releasing the release portion when the electrical wire is inserted.

The locking device of the release element can be formed, for example, by an opening in which the locking portion of the actuation element, for example formed by a projection, engages when the actuation element is in the actuated position. The actuation element is thus retained in a position in its actuated position by the form-fitting engagement of the locking portion in the opening of the release element, wherein the engagement can be released by adjusting the release leg, and the actuation element can thus be released from the actuated position to transfer the clamping leg into the open position.

The opening with which the locking portion of the actuation element engages in the actuated position can, for example, be formed in the release portion of the release element. By moving the release portion, the engagement can be released by the release portion being moved relative to the locking portion of the actuation element and thus releasing the locking connection.

In one embodiment, the connection terminal is part of a connection arrangement consisting of a plurality of connection terminals that are arranged in a row in a lined-up direction. The lined-up direction extends transversely to the insertion direction in which an electrical wire is to be attached to the connection terminal.

The connection terminals can abut one another and interact with one another in such a way that the side wall of one connection terminal also provides a side wall for an adjacent, additional connection terminal. A single connection terminal is therefore not closed toward the outside, but is only closed when a plurality of connection terminals are arranged next to each other in a row.

The connection terminals of the arrangement can be identical in design. However, the connection terminals can for example also differ in terms of their dimensions—for example, the width in the lined-up direction and the number and/or size of the insertion opening.

The housing of the connection terminal can, for example, be formed by two housing parts attached to one another in the lined-up direction, wherein adjacent connection terminals can jointly use the housing parts. Advantageously, it can be provided that the housing parts jointly hold the supporting end of the release element of the connection terminal in position, wherein the housing parts each have, for example, a connecting device. For this purpose, the supporting end of the release element can be fastened, for example, to the connecting devices of the housing parts. For example, the supporting end can be arranged between side walls, which extend in parallel with one another, of the housing parts in such a way that the supporting end is form-fittingly fixed between the side walls of the two housing parts and, for example, form-fittingly engages with the connecting devices of the housing parts. The supporting end is thus held between the housing parts of adjacent connection terminals which are arranged in a row and is also fixed by its supporting end in such a way that the release portion of the release element can be elastically deflected with respect to the supporting end, but the supporting end remains in position and can absorb torques.

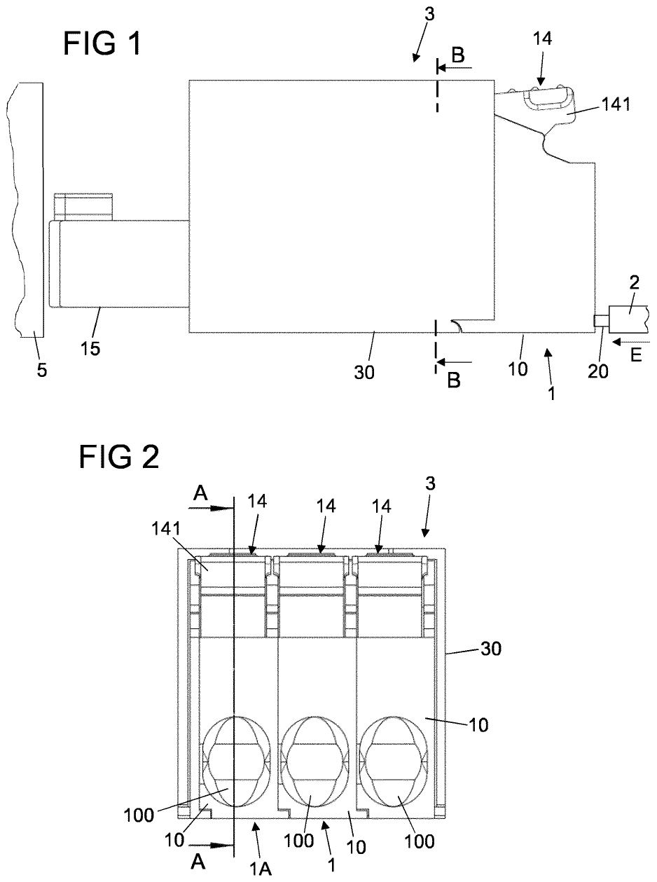

FIGS. 1 and 2 show an embodiment of a connection arrangement 3 which comprises a plurality of connection terminals 1, 1A which are jointly enclosed by an outer housing 30. The connection terminals 1, 1A are arranged in a row in a lined-up direction A and are jointly enclosed by the outer housing 30, wherein each connection terminal 1, 1A is assigned an insertion opening 100 in a housing 10, into which an electrical wire 2 can be inserted in an insertion direction E by means of a (stripped) conductor end 20 in order to connect the electrical wire 2 to the connection terminal 1, 1A.

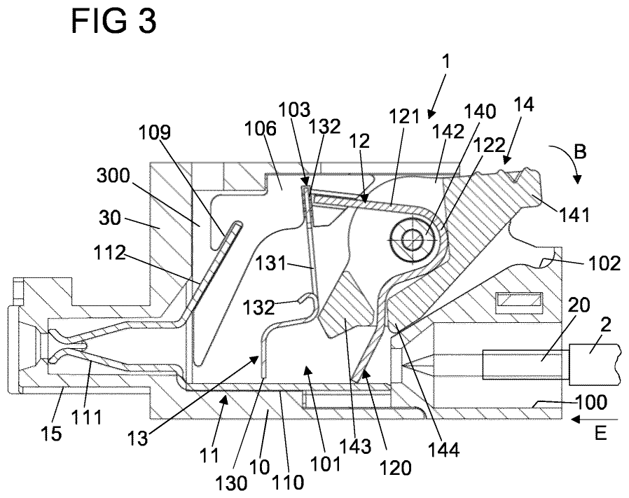

FIG. 3 is a sectional view along line A-A according to FIG. 2 of an embodiment of a connection terminal 1 which has a housing 10 with an insertion opening 100 formed therein for inserting an electrical wire 2 in an insertion direction E.

The housing 10 defines a receiving space 101 into which the electrical wire 2 is introduced by means of a stripped conductor end 20 when it is inserted into the insertion opening 100 in the insertion direction E. In a connected position, the wire 2 with the stripped conductor end 20 is located within the receiving space 101 and is electrically contacted via a clamping portion 120 of a spring element 12 by a contact element 11 in the form of a current bar such that the electrical wire 2 is electrically connected to the connection terminal 1.

The spring element 12 has a supporting leg 121 which is supported on a wall of the housing 10 in that the supporting leg 121 engages in a supporting opening 108 on a housing wall 106 such that the spring element 12 is fastened thereabove to the housing 10 thereby and is fixed to the housing 10. The clamping portion 120 can be elastically deflected relative to the supporting portion 121, in particular such that the clamping portion 120 clamps, in a clamping position, an electrical wire 2 connected to the connection terminal 1 and pushes this under elastic preload into contact with the contact element 11 and thus brings the wire 2 into electrical contact with the contact element 11 via its conductor end 20.

The contact element 11 has a contact portion 110 which extends in the housing 10 in a planar manner and against which the conductor end 20 of the electrical wire 2 is pressed by spring preload of the clamping leg 120 when the electrical wire 2 is connected to the connection terminal 1. The contact portion 110 is connected to a contacting unit 111 arranged in a plug connector portion 15, via which contacting unit the connection terminal 1 can be plugged into an associated mating electrical connector.

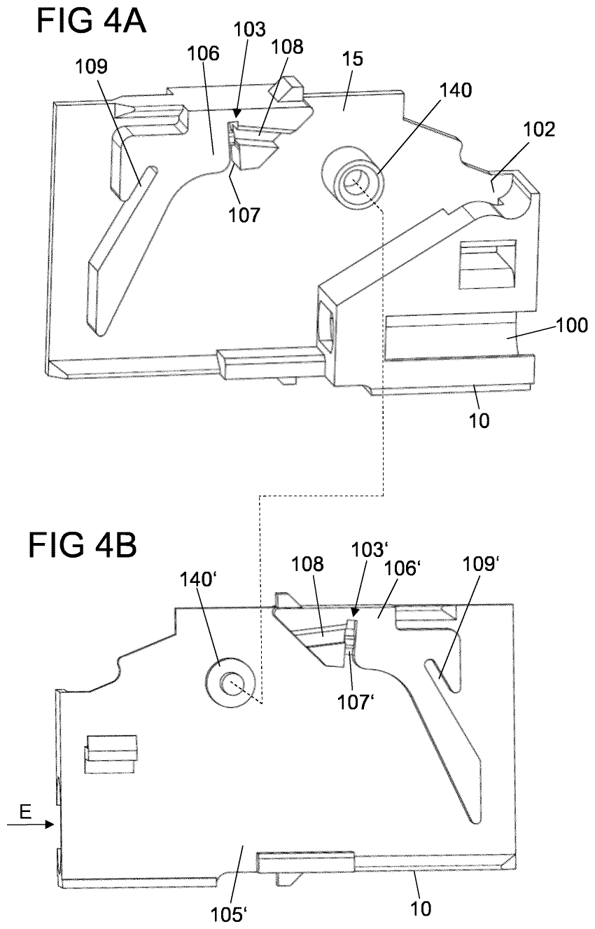

In the illustrated embodiment, the housing 10 of the connection terminal 1 is formed by housing parts 105, 105′ shown in FIGS. 4A and 4B. The adjacent connection terminals 1, 1A jointly use the housing parts 105, 105′. The housing 10 of one connection terminal 1 is thus formed by a housing part 105 and an adjacent housing part 105′ of an adjacent connection terminal 1A.

As can be seen from FIGS. 4A and 4B, the housing parts 105, 105′ of the connecting terminals 1, 1A arranged next to each other in a row are attached to one another and jointly housed in the outer housing 30 of the connection arrangement 3, as can be seen from FIG. 2.

An actuation element 14 is pivotably mounted on the housing 10 of the connection terminal 1 via a pivot shaft 140. The actuation element 14 can be pivoted about the pivot shaft 140 relative to the housing 10, wherein an actuating portion 141 is accessible from outside the housing 10 via an actuating opening 102 and can thus be actuated by a user—for example, using a tool.

In the illustrated exemplary embodiment, the pivot shaft 140 is formed on the housing part 105 in which a shaft journal 140′ of the housing part 105′ engages and thus completes the pivot bearing for the actuation element 14 on the housing 10, as can be seen from FIGS. 4A, 4B.

The actuation element 14 is operatively connected to the clamping portion 120 of the spring element 12. For this purpose, the spring element 12 passes through a through-opening 142 inside the actuation element 14 such that the spring element 12 grasps around the pivot shaft 140 by means of a curved intermediate portion 122, as can be seen from FIG. 3. The supporting portion 121 protrudes from the opening 142 on a first side and is supported on the housing 10. The clamping leg 120, on the other hand, protrudes from the actuation element 14 on a remote second side and thus extends within the receiving space 101 in the region of the insertion opening 100 in such a way that the spring element 12 can act via the clamping leg 120 upon an electrical wire 2 inserted into the insertion opening 100 for making contact with the contact element 11 and also for mechanical locking.

The connection terminal 1 has a release element 13 which is fastened to the housing 10 via a supporting end 132 and is thereby supported in a torque-tight manner relative to the housing 10. A release portion 130 extends from the supporting end 132 and projects into the receiving space 101 substantially transversely to the insertion direction E and thus extends in a region aligned with the insertion opening 100.

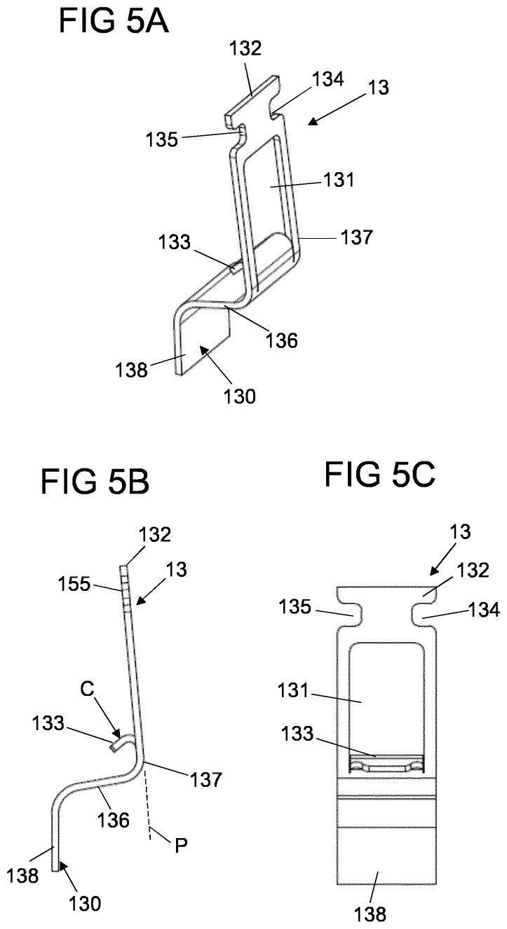

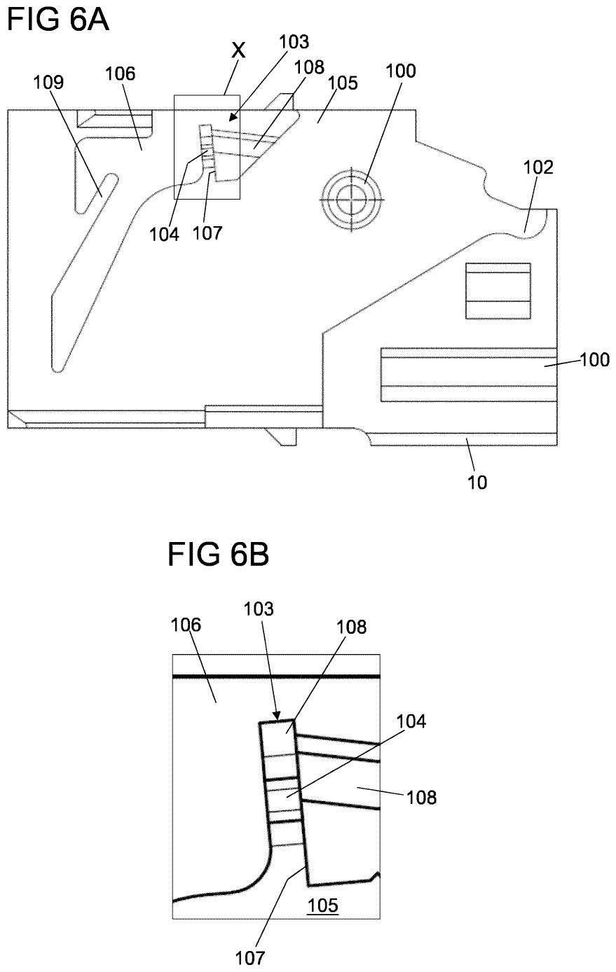

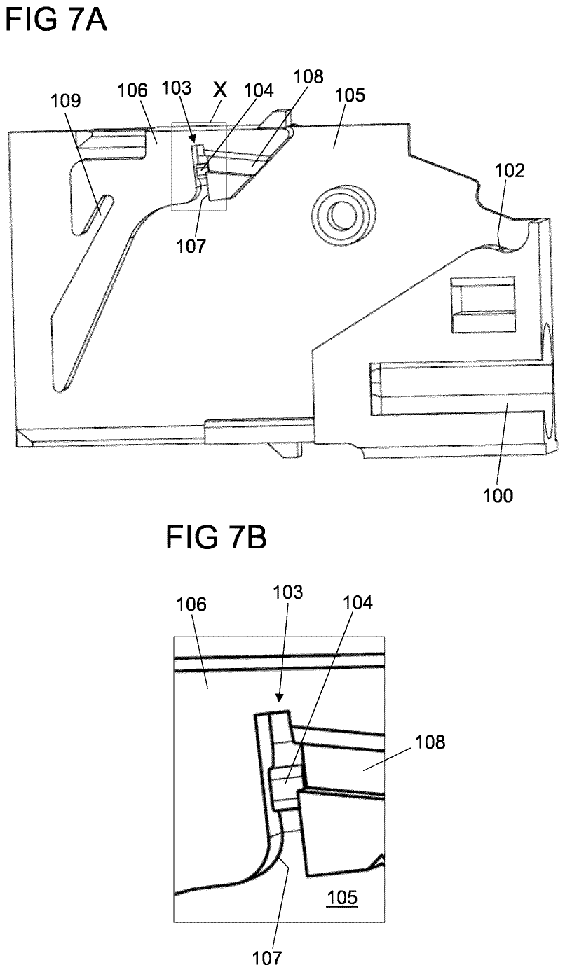

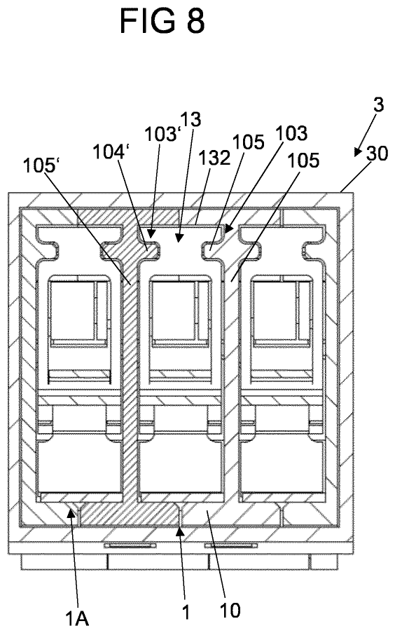

As can be seen from the separate view of the release element 13 according to FIG. 5A-5C, the detailed views of the housing part 105 according to FIGS. 6A, 6B and 7A, 7B and the sectional view according to FIG. 8, the supporting end 132 of the release element 13 is interlockingly connected to connecting devices 103, 103′ of the housing parts 105, 105′ forming the housing 10 of the connection terminal 1. The supporting end 132 of the release element 13 formed by a strip-shaped spring element has recesses 134, 135 in its opposite lateral edges, which, in the mounted position of the release element 13, engage with projection elements 104, 104′ on the connecting devices 103, 103′.

The connecting devices 103, 103′ are each formed by an engagement opening 107, 107′ into which the supporting end 132 engages such that the supporting end 132 is interlockingly received on the housing 10. The supporting end 132 is interlockingly connected to the housing 10 such that the supporting end 132 cannot slide out of the connecting devices 103, 103′ and, in addition, the supporting end 132 is supported on the housing 10 in such a way that, when the release portion 130 is elastically deflected, torques can be absorbed at the supporting end 132 and diverted into the housing 10, and the supporting end 132 thereby remains in position relative to the housing 10.

The engagement opening 107, 107′ is formed in a wall portion 106, 106′ of each housing part 105, 105′, which protrudes from a planar side wall of the housing part 105, 105′, as can be seen from FIGS. 4A and 4B.

As can be seen from the sectional view according to FIG. 8, the supporting end 132 of the connection terminal 1 is received between the housing parts 105, 105′ of the adjacent connection terminals 1, 1A such that the supporting end 132 is interlockingly held on the connecting devices 103, 103′ that mirror each other of the housing parts 105, 105′ of the connection terminals 1, 1A. The housing parts 105, 105′ thus jointly form the housing 10 of the connection terminal 1. The release element 13 is fixed to the connection terminal 1 by the housing 10 and is thus held in position relative to the housing 10 of the connection terminal 1 when the connection terminal 1 is mounted and ready for operation.

The release leg 130 serves to cooperate with an electrical wire 2 inserted into the insertion opening 100, in particular to automatically connect the electrical wire 2 to the connection terminal 1 by releasing the clamping leg 120.

The release element 13 has an opening 131 with which the actuation element 14 engages via a locking portion 143 in the form of a projection when the actuation element 14 has been transferred into an actuated position in an actuating direction B. In the actuated position, the actuation element 14 engages in the opening 131 by means of the locking portion 143 and is thereby lockingly held on the release portion 130 so that the actuation element 14 is locked in the actuated position.

In the exemplary embodiment shown, the release leg 130 is bent. Between a free end 138 of the release portion 130 remote from the supporting end 132 and a leg portion 137 of the release portion 130 aligned with the supporting end 132 and in which the opening 131 is formed, an intermediate portion 136 extends transversely between the free end 138 of the release portion 130 and the leg portion 137 of the release portion 130 bearing the opening 131. By suitably shaping the release element 13, the release element 13 can be adapted to the installation space conditions within the receiving space 101 of the housing 10.

If the actuation element 14 is actuated in the actuating direction B and thereby pivoted around the pivot shaft 140 relative to the housing 10, the actuation element 14 entrains the clamping leg 120 of the spring element 12 via an active portion 144 and thereby moves the clamping leg 120 into an open position. In the open position, the free end of the clamping leg 120 is remote from the contact portion 110 of the contact element 11 and thus clears a region within the receiving space 101 aligned with the insertion opening 100 in the insertion direction E such that an electrical wire 2 can be inserted into the insertion opening 100 unhindered by the clamping leg 120 and thus connected to the connection terminal 1 substantially without any force.

If an electrical wire 2 with a stripped conductor end 20 is inserted into the insertion opening 100 and thereby introduced into the receiving space 101 in the insertion direction E while the actuation element 14 is in the actuated position and thus the clamping leg 120 is in the open position, the wire 2 comes into abutment with the release leg 130 of the release element 13 and elastically deflects it relative to the supporting end 132 and thus to the housing 10. As a result, the release portion 130 is moved in the insertion direction E relative to the locking portion 143 of the actuation element 14 so that the locking portion 143 disengages from the opening 131, and thus the actuation element 14 is released from the actuated position.

On a side of the opening 131 facing the free end 138 of the release portion 130, a run-on element 133 is formed by a bent portion of the release element 13 formed as a sheet metal element, against which the locking portion 143 rests in the locking position and onto which the locking portion 143 runs when the locking engagement is released. Since the electrical wire 2 acts on the release portion 130 with a lever arm that is larger than the lever arm acting on the locking portion 143, the release portion 130 can be deflected with little force that is to be applied by the electrical wire 2, and thus the locking engagement can be released easily and reliably when the electrical wire 2 is inserted.

As can be seen from FIG. 3 in conjunction with FIG. 5B, the run-on element 133 is bent in a direction toward the leg portion 137 of the release portion 130 which faces away from the actuation element 14 in the insertion direction E. In the locked position, in which the locking portion 143 engages in the opening 131, the locking portion 143 comes to rest at a contact point C on the run-on element 133, which is offset from a plane P, along which extends the supporting portion 137 aligned with the supporting end 132. As a result, when the actuation element 14 engages the release element 13 by the locking portion 143 engaging in the opening 131 in the leg portion 137, the actuation element 14 exerts a torque on the release element 13 via the locking portion 143, which torque is directed in a counterclockwise direction in the sectional view according to FIG. 3 and thus in a direction that additionally reinforces the locking engagement between the locking portion 143 and the opening 131.

When the locking engagement is established, the release portion 130 is elastically deflected and the locking portion 143 slides into the opening 131, and the release portion 130 then returns to its initial position in which the release portion 130 engages the locking portion 143 of the actuation element 14. The release portion 130 is loaded by the locking portion 143 of the actuation element 14 on the run-on element 133 and is pushed in the direction of the actuation element 14 by the resulting torque such that the locking portion 143 moves into complete engagement with the opening 131 in the leg portion 137.

After the locking engagement is released when an electrical wire 2 is inserted, the actuation element 14 moves out of the actuated position due to the elastic preload on the clamping leg 120 and is returned counter to the actuating direction B. The clamping portion 120 comes into clamping abutment with the electrical wire 2 and thereby pushes the conductor end 20 into contacting abutment with the contact element 11 so that the wire 2 is electrically connected to the connection terminal 1 and is also mechanically locked.

Since the actuation element 14 is moved out of the actuated position after the locking engagement is released, a user can safely and reliably detect that the connection terminal 1 has been released and the electrical wire 2 is thus connected to the connection terminal 1. The risk of incorrect operation is thus reduced.

If the electrical wire 2 is to be released from the connected position and re-removed from the connection terminal 1, the actuation element 14 can be transferred back into the actuated position so that the clamping portion 120 is not in abutment with the wire 2. The wire 2 can thus be removed from the connection terminal 1 substantially without any force.

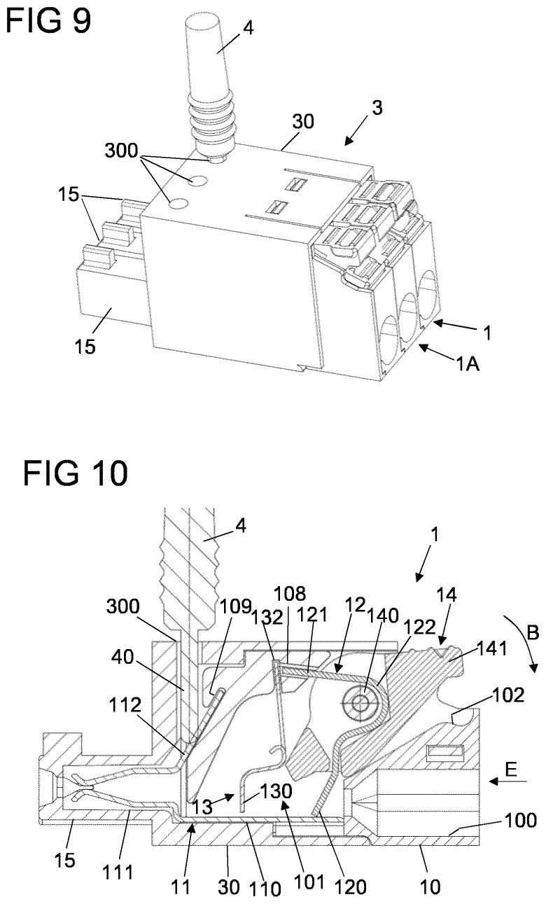

In the connection arrangement according to FIGS. 1 and 2, test openings 300, into each of which a testing tool 4 having a test probe 40 can be inserted as shown in FIGS. 9 and 10, are formed on the outer housing 30. Each test opening 300 is assigned to one of the connection terminals 1, 1A of the connection arrangement 3 such that a voltage can be tapped at a connection terminal 1, 1A for testing purposes via a testing tool 4, and it is therefore possible to check at which potential the connection terminal 1, 1A is located.

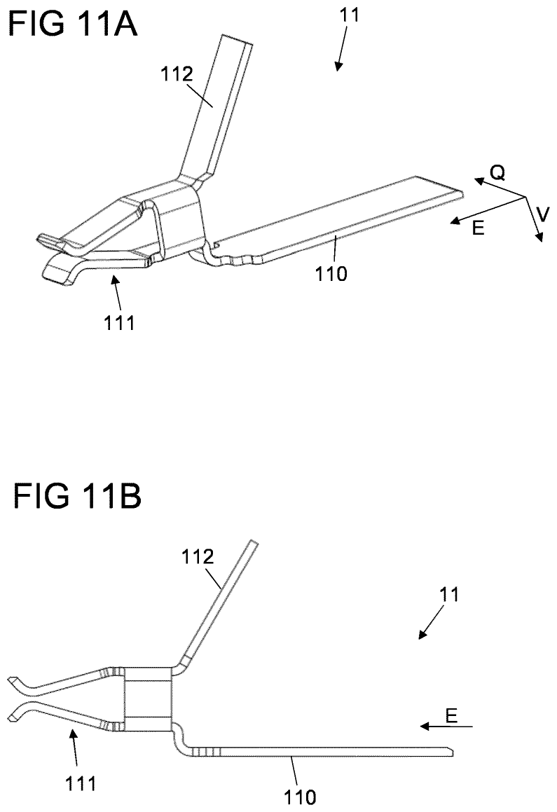

As can be seen from the separate views according to FIGS. 11A, 11B, the contact element 11 has different legs which extend from the contacting unit 111. A first leg forms the contact portion 110 which extends in a planar manner along a plane which is spanned by the insertion direction E and a transverse direction Q pointing transversely to the insertion direction E. In contrast, a second leg forms a tapping portion 112 which is positioned obliquely to the plane of the contact portion 110 and is thus oriented obliquely to the insertion direction E and also obliquely to a vertical direction V perpendicular to the insertion direction E and to the transverse direction Q.

In the exemplary embodiment shown, the testing tool 4 can be inserted along the vertical direction V into the test opening 300 assigned to a connection terminal 1, 1A in order to make contact with the tapping portion 112 of the contact element 11 of the connection terminal 1, 1A by means of the test probe 40.

The legs each extend from the contacting unit 111, which in the exemplary embodiment shown is formed by a contact socket having contact blades between which, for example, a contact pin of a mating connector can be inserted for plugging the connection arrangement 3 into the mating connector.

As can be seen from FIGS. 3 and 10, the contact portion 110 points with a free end from the contacting unit 111 towards the insertion opening 100. In contrast, the tapping portion 112 extends obliquely in the housing 10 into the region, associated with the corresponding connection terminal 1, of a test opening 300.

In this case, with a free end, the tapping portion 112 is received in engagement openings 109, 109′ on the raised wall portions 106, 106′ of the housing parts 105, 105′, as can be seen from FIG. 10 in conjunction with FIGS. 4A, 4B, such that the tapping portion 112 is supported thereabove on the housing 10 formed by the housing parts 105, 105′.

In the exemplary embodiment of the connection terminal 1 shown, the supporting leg 121 of the spring element 12 is received in supporting openings 108, 108′ of the housing parts 105, 105′ and supported thereabove on the housing 10. The housing 10 is made of an electrically insulating material, in particular a plastic material, so that the spring element 12 does not make electrical contact with the contact element 11 when the clamping leg 120 is in the open position and is therefore remote from the contact portion 110 of the contact element 11. However, because a test tap is carried out at the contact element 11 via the tapping portion 112, a voltage can be tapped directly at the contact element 11 by means of the testing tool 4, regardless of the position of the clamping leg 120 of the spring element 12.

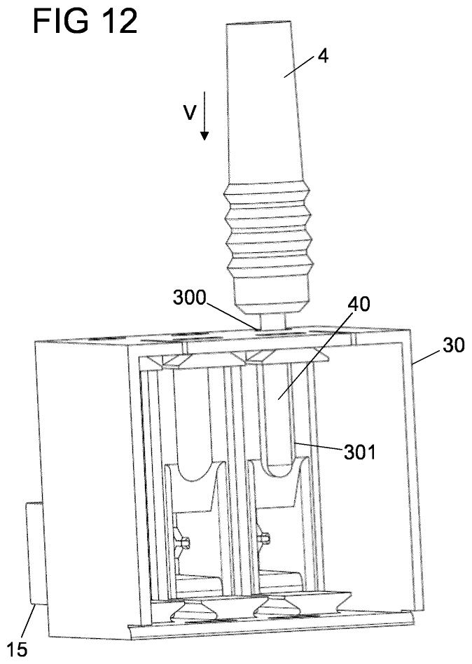

As can be seen from the separate view of the outer housing 30 of the connection arrangement 3 according to FIG. 12, guide portions 301 in the form of longitudinally extended grooves having a semicircular cross-section are formed in the region of the test openings 300, along which guide portions the test probe 40 of the testing tool 4 slides when inserted into the test opening 300 associated with a connection terminal 1. The test probe 40 is thus guided on the housing 30 and into the region of the tapping portion 112 such that the test probe 40 reliably makes contact with the end portion 112 when said test probe is inserted into the test opening 300.

The contact element 11 can be formed as a sheet metal element, e.g., as a stamped and bent part, and can therefore be produced easily and inexpensively.

The concept on which the invention is based is not limited to the embodiment described above, but can also be realized in another way.

The release element can, for example, be designed as a sheet metal element.

However, other designs of the release element are also conceivable and possible—for example, production from plastic.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

1, 1A Connection terminal
10 Housing
100 Insertion opening
101 Receiving space
102 Engagement opening
103, 103′ Connecting device
104, 104′ Form-fitting element
105, 105′ Housing part
106, 106′ Wall portion
107, 107′ Side wall
108, 108′ Supporting opening
109, 109′ Engagement opening
11 Contact element (current bar)
110 Contact portion
111 Contacting unit
112 Tapping portion
12 Clamping spring
120 Clamping leg
121 Supporting leg
122 Intermediate portion
13 Release element
130 Release leg
131 Locking device (locking opening)
132 Supporting end
133 Run-on element
134, 135 Form-fitting element (recess)
136 Intermediate portion
137 Leg portion
138 End
14 Actuation element
140 Pivot shaft
141 Actuating portion
142 Through-opening
143 Locking portion
144 Active portion
15 Plug connector portion
3 Connection arrangement
30 Outer housing
300 Test opening
301 Guide portion
4 Testing tool
40 Test probe
5 Electrical assembly
A Lined-up direction
B Actuating direction
C Contact point
E Insertion direction
Q Transverse direction
V Vertical direction

1. A connection terminal for connecting an electrical wire comprising:
a housing which has an insertion opening into which the electrical wire is insertable for connection to the connection terminal;
a contact element which is arranged on the housing and has a contact portion configured to make electrical contact with the electrical wire;
a spring element arranged on the housing and having a clamping leg which is adjustable relative to the housing and which, in a clamping position, is configured to act upon the electrical wire so as to make contact with the contact portion and, in an open position, is remote from the contact portion relative to the clamping position; and
a release element,
wherein the clamping leg is retained in a position relative to the housing in the open position, and the release element is configured to cooperate with the electrical wire upon insertion of the electrical wire into the insertion opening so as to release the clamping leg from the open position, and
wherein the contact element has a contacting unit configured to make contact with an associated electrical assembly, a first leg extending from the contacting unit and forming the contact leg, and a second leg extending from the contacting unit and forming a tapping portion configured to make electrical contact with a testing tool.

2. The connection terminal of claim 1, wherein the contact portion extends in a planar manner along a plane which is spanned by an insertion direction in which the electrical wire is insertable into the insertion opening, and a transverse direction pointing transversely to the insertion direction.

3. The connection terminal of claim 2, wherein the tapping portion extends obliquely to the insertion direction.

4. The connection terminal of claim 1, wherein the housing has a test opening into which the testing tool is introducible so as to make contact with the tapping portion.

5. The connection terminal of claim 4, wherein the testing tool is introducible into the test opening along a vertical direction, and
wherein the tapping portion extends obliquely to the vertical direction.

6. The connection terminal of claim 1, wherein the tapping portion engages with an end, remote from the contacting unit, in an engagement opening on the housing and is supported above the end on the housing via the engagement opening.

7. The connection terminal of claim 1, wherein the contact portion points with an end, remote from the contacting unit in a direction of the insertion opening.

8. The connection terminal of claim 1, wherein the contacting unit is configured to plug into the associated electrical assembly by a contact socket.

9. The connection terminal of claim 1, wherein the clamping leg is configured to push or pull the electrical wire into abutment with the contact element by spring force.

10. The connection terminal of claim 1, wherein the spring element has a supporting leg which is supported on the housing and relative to which the clamping leg is elastically deflectable.

11. The connection terminal of claim 10, wherein the supporting leg is configured to engage in a supporting opening on the housing and is supported above the supporting opening on the housing via the supporting opening.

12. The connection terminal of claim 1, wherein the release element has a release leg,
wherein the housing defines a receiving space into which the electrical wire is introducible by being inserted into the insertion opening, and
wherein the release leg extends into the receiving space so as to cooperate with the electrical wire.

13. The connection terminal of claim 12, wherein the electrical wire is insertable into the insertion opening in an insertion direction, and
wherein the release leg extends transversely to the insertion direction into the receiving space.

14. The connection terminal of claim 13, wherein the release element has a supporting end relative to which the release leg is elastically adjustable by cooperating with the electrical wire inserted into the insertion opening.

15. The connection terminal of claim 14, wherein the housing has a connecting device to which the supporting end is secured.

16. The connection terminal of claim 1, further comprising:
an actuation element which is adjustably arranged on the housing and is adjustable from a non-actuated position to an actuated position to transfer the clamping leg into the open position.

17. The connection terminal of claim 16, wherein the actuation element is configured to engage with the release element in the actuated position so as to hold the actuation element in the actuated position.

18. The connection terminal of claim 16, wherein the actuation element is mounted on the housing so as to be pivotable about a pivot shaft and has an actuating portion for actuation by a user and an active portion configured to act upon the clamping leg.

19. A connection arrangement, comprising:
the connection terminal of claim 1; and
a further connection terminal which is arranged adjacently to the connection terminal in a lined-up direction that extends transversely to an insertion direction, in which insertion direction the electrical wire is insertable into the insertion opening,
wherein the housing of the connection terminal comprises two housing parts attached to one another in the lined-up direction.
